(19) United States
(12) Patent Application Publication
(10) Pub. No.: US 2017/0220498 A1
(43) Pub. Date: Aug. 3, 2017

(54) APPARATUS FOR PERSONALITY AND DATA TRANSFER VIA PHYSICAL MOVEMENT OF A FAST MEMORY TRANSFER DEVICE

(71) Applicant: Symbolic IO Corporation, Holmdel, NJ (US)

(72) Inventor: Brian M. Ignomirello, Holmdel, NJ (US)

(21) Appl. No.: 15/390,570

(22) Filed: Dec. 26, 2016

Related U.S. Application Data
(63) Continuation-in-part of application No. 15/089,729, filed on Apr. 4, 2016.
(60) Provisional application No. 62/296,044, filed on Feb. 16, 2016.
(60) Provisional application No. 62/289,686, filed on Feb. 1, 2016.

(51) Int. Cl. G06F 13/36; G06F 13/42; G06F 13/40; G06F 21/85

(52) U.S. Cl. CPC G06F 13/36; G06F 21/85; G06F 13/4282; G06F 13/4068

(57) ABSTRACT

System and method to transferably store a system state of an electronic component, the system including a processor and a circuit module. The processor is configured to decompose the system state into a plurality of data vectors, and to map each of the plurality of data vectors to a respective bit marker. The circuit module is removably coupled to the electronic component, the circuit module including a memory and a transceiver. The transceiver is coupled to the memory and to a communication link between the memory and the processor, the transceiver operable to send and to receive data at a rate faster than 640 MBps. Data sent and received by the transceiver comprises bit markers mapped by the processor.

### CROSS-REFERENCE TO RELATED APPLICATIONS

This application claims the benefit of U.S. Provisional Application Ser. No. 62/296,044, filed on Feb. 16, 2016, the entire content of which is hereby incorporated by reference in its entirety. This application also is a continuation in part of U.S. patent application Ser. No. 15/089,729, filed on Apr. 4, 2016, which in turn claims the benefit of 62/289,686, filed on Feb. 1, 2016. The content of all applications referenced above are incorporated herein by reference in their entireties.

### BACKGROUND

Field

Embodiments of the present disclosure generally relate to system cloning, and in particular to cloning a computer system via transfer of a physical object.

Description of Related Art

Systems and methods of compact data storage by use of bit markers are known. For example, U.S. Patent Application Publication No. 2014/0223118, U.S. Patent Application Publication No. 2014/0279911, and U.S. Pat. No. 9,467,294, each of which is hereby incorporated by reference in their entireties, describe systems, apparatus and methods to use bit markers, marker tables, mediators, and related structure and/or functions to quickly and compactly store data, and retrieve the data quickly.

### BRIEF SUMMARY

In one embodiment, a removable portion of an electronic equipment may include a processor coupled to data storage. The removable portion is configurable to store a backup of a first computer system, such that the computer system may be functionally restored on a second, separate computer system by physically moving the removable portion from the first computer system to the second computer system. In some embodiments, the removable portion may include a multimodal status indicator.

Embodiments in accordance with the present disclosure include a system and method to transferably store a system state of an electronic component, the system including a processor and a circuit module. The processor is configured to decompose the system state into a plurality of data vectors, and to map each of the plurality of data vectors to a respective bit marker. The circuit module is removably coupled to the electronic component, the circuit module including a memory and a transceiver. The transceiver is coupled to the memory and to a communication link between the memory and the processor, the transceiver operable to send and to receive data at a rate faster than 640 MBps. Data sent and received by the transceiver comprises bit markers mapped by the processor.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present disclosure will become apparent upon consideration of the following detailed description of embodiments thereof, especially when taken in conjunction with the accompanying drawings wherein like reference numerals in the various figures are utilized to designate like components, and wherein:

FIG. 1A is a simplified oblique view of a first electronic component with a detachably attached portion, in accordance with an embodiment of the present disclosure;

FIG. 1B is a simplified oblique view of a first electronic component with a detachable portion detached from the first electronic component, in accordance with an embodiment of the present disclosure; and

FIG. 1C is a simplified oblique view of a second electronic component with a detachable portion from the first electronic component attached to the second electronic component, in accordance with an embodiment of the present disclosure.

FIG. 2A is a simplified oblique view of a first electronic component with a detachable portion of a faceplate detached from the first electronic component, in accordance with an embodiment of the present disclosure; and

FIG. 2B is an overhead plan view of a detachable circuit module in accordance with an embodiment of the present disclosure;

FIG. 3 illustrates at a high level of abstraction a functional block diagram of a first and second electronic component, in accordance with an embodiment of the present disclosure; and

FIG. 4 illustrates a method in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The exemplary systems and methods of this disclosure will also be described in relation to software, modules, and associated hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

As used herein, the term “module” refers generally to a logical sequence or association of steps, processes or components. For example, a software module may comprise a set of associated routines or subroutines within a computer program or encoded within firmware. Alternatively, a module may comprise a substantially self-contained hardware device. A module may also comprise a logical set of processes irrespective of any software or hardware implementation.

A module that performs a function also may be referred to as being configured to perform the function, e.g., a data module that receives data also may be described as being configured to receive data. Configuration to perform a function may include, for example: providing and executing computer code in a processor that performs the function; providing provisionable configuration parameters that control, limit, enable or disable capabilities of the module (e.g., setting a flag, setting permissions, setting threshold levels used at decision points, etc.); providing a physical connection, such as a jumper to select an option, or to enable/disable an option; attaching a physical communication link; enabling a wireless communication link; providing electrical circuitry that is designed to perform the function without use of a processor, such as by use of discrete components and/or non-CPU integrated circuits; energizing a circuit that performs the function (e.g., providing power to a transceiver circuit in order to receive data); and so forth.

As used herein, the term “transmitter” may generally comprise any device, circuit, or apparatus capable of transmitting a signal. As used herein, the term “receiver” may generally comprise any device, circuit, or apparatus capable of receiving a signal. As used herein, the term “transceiver” may generally comprise any device, circuit, or apparatus capable of transmitting and receiving a signal. As used herein, the term “signal” may include one or more of an electrical signal, a radio signal, an optical signal, an acoustic signal, and so forth.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes a computer readable signal medium such as a propagating signal. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

An electronic component (e.g., a desktop PC, a rack-mounted server, etc.) commonly includes a processor coupled to a memory. A case often forms at least part of the outer periphery. Some electrical controls or indicators may be accessible or visible on or in the case, e.g., a power switch, various LEDs, etc. However, the portions of the outer periphery with the electrical controls or indicators are not designed to be removable without major disassembly (e.g., by taking apart the electronic component, or by opening up the case and exposing an interior portion of the case, etc.), and in particular are not designed to be removable while the electronic component continues to operate.

In contrast, embodiments in accordance with the present disclosure provide a removable portion of an electronic component. The removable portion includes a memory, and the removable portion is designed to be removable and re-installable while the rest of the electronic component continues to operate with at least a portion of its functions. The removable portion may be removable by hand and/or by simple hand tools (e.g., a knurled screw head that could be turned either by hand or by screwdriver, etc.).

In some embodiments, the removable portion may include a removable circuit board, a removable faceplate that includes electronic components, a removable portion of the faceplate, and so forth. The removable faceplate or portion thereof may further include a processor, in addition to a processor in the remainder of the electronic component. The removable portion may be electrically and physically coupled to the electronic component such that the removable portion is hot-swappable, i.e., that the removable portion may be detached and/or reattached without shutting down the rest of the electronic component. The removable portion may include a high-speed communication interface (faster than USB speeds_{[asw1]}, e.g., PCIe speed or faster) between the removable portion and the electronic component.

In some embodiments, the electronic component may act as a block-addressable device to store data in a bit marker format. Bit marker based storage devices do not rely upon a file system to store and retrieve data from the storage device. The electronic component may include a device controller to manage low-level control of the storage device, based upon relatively higher-level control from the processor.

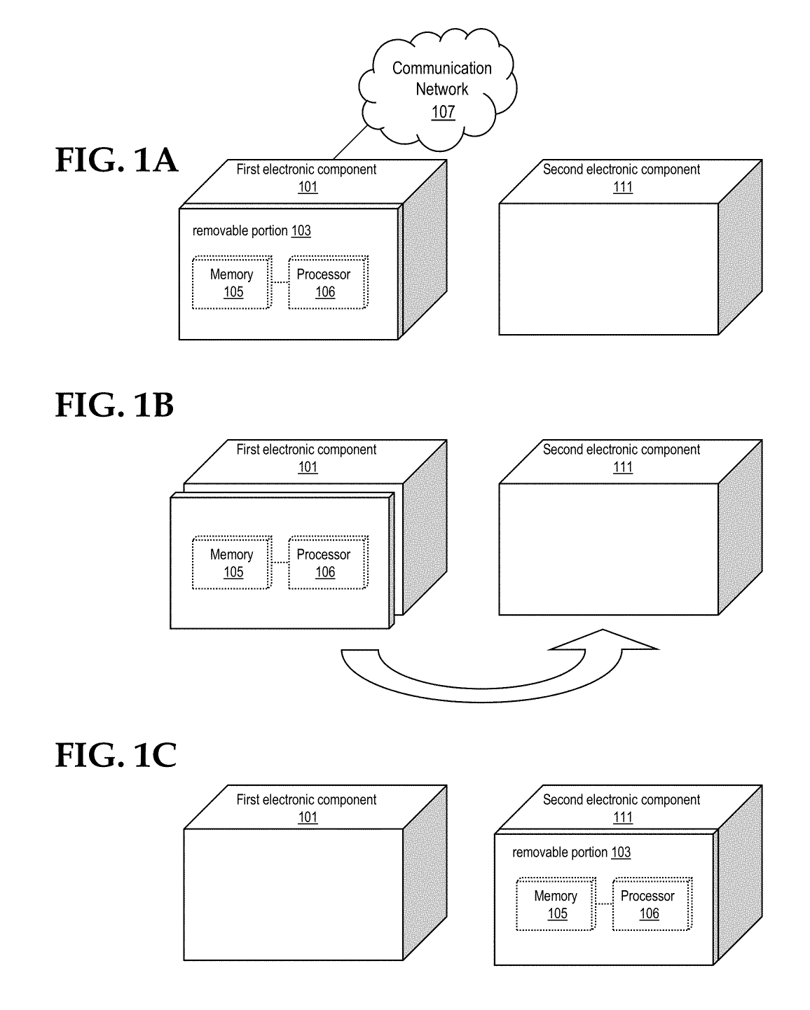

FIG. 1A illustrates a simplified oblique view of a first electronic component 101 coupled to a removable portion 103, in accordance with an embodiment of the present disclosure. Removable portion 103 includes a memory 105, which also may be coupled optionally to a processor 106 housed in removable portion 103. First electronic component 101 may incorporate a separate processor and memory (not illustrated) to support operations of first electronic component 101. FIG. 1A further illustrates a second electronic component 111 without a faceplate. In some embodiments, second electronic component 111 may be substantially identical to first electronic component 101.

In some embodiments, first electronic component 101 may be executing backup functions, e.g., by use of bit markers, marker tables, mediators, and related structure and/or function technology. In some embodiments, the backup functions may be implemented by way of a fast system state clone backup. At least a portion of the data created by the backup functions executing in first electronic component 101 may be stored in memory 105, by use of an electrical connection between memory 105 and the processor in first electronic component 101. In some embodiments, backup functions may be performed by processor 106. In some embodiments, a portion of the data (e.g., bit markers) may be stored in memory 105, and a separate portion of the data (e.g., a marker table) may be stored in a separate memory (not illustrated), separate from memory 105 (e.g., a memory within first electronic component 101 or a memory accessible via network 107).

In some embodiments, the data created by the backup functions is substantially sufficient to characterize a complete system state of electronic component 101, including installed programs, operating programs, data used by installed and/or operating programs, memory (including RAM and disk) contents, machine state in a finite state machine sense, network and infrastructure configurations (e.g., identities of components accessible by the system), security information and permissions (e.g., identities of trusted entities and an associated level of trust), data objects including the data itself, and so forth. The complete system state may also be referred to as a personality of electronic component 101. In some embodiments, the data created by the backup functions also may include additional electronic components (not illustrated) coupled to electronic component 101 through a communication network 107 such as an intranet or the Internet.

FIG. 1B illustrates removable portion 103 removed from first electronic component 101, in preparation for movement to second electronic component 111. In some embodiments, removal of removable portion 103 from electronic component 101 may generate a command or signal that causes from electronic component 101 to transition into a different operating state, which may be referred to as a paralyzed operating state. For example, core functions may continue operating (e.g., similar to breathing and heartbeat in a medical context), but non-core functions may be restricted or inhibited (e.g., similar to loss of limb motion in a medical context). In some embodiments, the different operating state may have reduced capabilities, e.g., lock a user out of invoking additional functions, inhibit instantiation of additional virtual machines (VM), inhibit usage of or access to additional resources, and so forth. For example, additional resources may include computing resources or CPU utilization percentage, memory usage, communication resources, usage of external resources, and so forth. In some embodiments, the different operating state may be restricted to running what was already running in first electronic component 101, prior to removal of removable portion 103. In some embodiments, if removable portion 103 is shut down with removable portion 103 removed, restart of first electronic component 101 may be inhibited. Inhibited restart or operation of first electronic component 101 may be accomplished by a hardware security module. In some embodiments, the hardware security module may be implemented as part of processor 106.

To facilitate detection of a removal of removable portion 103 from electronic component 101, some embodiments actively may exchange a signal between removable portion 103 and electronic component 101. The exchanged signal may be a periodic signal such as a heartbeat signal or an AC voltage, or a stead-state signal such as a DC voltage, or a signal used by a proximity sensor (e.g., optical, infrared, ultrasonic, etc.), or an RFID tag, etc. A loss of ability to detect the signal may be interpreted as an indication that removable portion 103 has been removed from electronic component 101. In other embodiments, a detectable condition may be used passively to detect whether removable portion 103 has been removed from electronic component 101, e.g., by magnetic effects, pressure, weight, presence or absence of a resistance or open circuit, exposure to air as indicated by an oxygen or nitrogen sensor, etc.

It should be noted that bit markers stored in memory 105 by themselves are insufficient to completely recreate the original data. Access to a bit marker table also is required to completely recreate the original data. The bit marker table may be stored in a separate memory, e.g., a memory in first electronic component 101 or in a memory accessible through a communication network 107. In contrast, data stored in a memory managed by conventional electronic components or operating systems (e.g., in a USB flash drive) is stored using a paradigm of blocks and a file table to associate blocks (or other physical or logical portions of the memory such as sectors) with files. Therefore, recovery of data from conventional memory storage is possible, and complete files may be recovered even without access to a file table by combining or rearranging recovered blocks (e.g., by trial and error combination of blocks). Therefore, embodiments in accordance with the present disclosure provide improved data security if custody of removable portion 103 is compromised while it is removed from first electronic component 101, since the data cannot be recreated from removable portion 103 alone.

In some embodiments, data stored in memory 105 may be encrypted in order to provide additional data security if the physical security of removable portion 103 is compromised. In some embodiments, processor 106 may be used to support encryption/decryption functions, or additional data security processes.

In some embodiments, a data connection between removable portion 103 and first electronic component 101 may be provided as a high-speed data link, e.g., a dual in-line memory module (DIMM) slot on a motherboard of first electronic component 101, the DIMM slot providing a Peripheral Component Interconnect Express (PCIe) interface. The speed of PCIe 4.0 in a 16-lane DIMM slot is up to 31.508 GBytes/sec. A fast communication link facilitates usage of memory 105 for system backups. Slower data links such as universal serial bus (USB) are not preferable, due to the combination of amount of data to transfer and time constraints in transferring the data. For example, USB 2.0 is limited to 60 megabytes per second (MBps), and USB 3.0 is limited to 640 MBps. Achievable transfer speeds also depend upon the read/write capability of the external device connected to the USB port. For example, an upper limit to write speeds of USB flash drives typically is 30 MBps or less. When an amount of RAM in a computer system can exceed 8 GB, and disk drives can be several terabytes (TB) in capacity, it would take an unacceptably long time to save the system state to a slow memory, or through a slow memory interface, as described in this paragraph.

FIG. 1C illustrates removable portion 103 coupled to second electronic component 111. After coupling, second electronic component 111 may then take on a complete operating system state stored in memory 105. For example, if a complete operating system state of first electronic component 101 has been stored in memory 105, then the complete operating system state of first electronic component 101 may be restored on second electronic component 111. If memory 105 includes a plurality of backups (e.g., separate electronic components, or a single electronic component at different times), an operating system of second electronic component 111 may have an ability to select which backup to restore on second electronic component 111.

In one usage scenario, first electronic component 101 may be a data collection system, collecting data in an unattended manner from sensors. Service personnel may access first electronic component 101 at certain times (e.g., once per day, once per week, or on an irregular schedule, etc.). The data from first electronic component 101 may be transferred en masse by removing removable portion 103 from first electronic component 101 and attaching it to second electronic component 111. A second removable portion 103 may be available on hand to replace the first removable portion 103 so that first electronic component 101 can be returned to service quickly. Removable portion 103 may be configured to store data using bit marker technology, thereby increasing data security during transfer, as compared to conventional memory such as a USB flash drive.

In another usage scenario, a company may use first electronic component 101 to manage a plurality of end-user desktop computers or virtual machines. A complete system backup of all systems within a domain of the company may be stored in memory 105. If an end-user's machine needs to be cloned (e.g., due to a hardware failure), removable portion 103 may be moved to a target machine (e.g., second electronic component 111), and a partial restore may be performed on second electronic component 111 (e.g., to restore only the end-user's machine).

In another usage scenario in accordance with an embodiment of the present disclosure, removable portion 103 may be used to transfer a system state from first electronic component 101 to second electronic component 111. In such a scenario, first a system state of first electronic component 101 may be stored within removable portion 103, e.g., by use of bit marker technology and a fast system state clone as described in application Ser. No. 15/089,837 (published as 2016/0217047), application Ser. No. 13/908,239 (now U.S. Pat. No. 9,467,294), application Ser. No. 13/756,921 (published as 2014/0223118), and application Ser. No. 13/797,093 (published as 2014/0279911), all of which are incorporated by reference in their entireties.

Second, a command or the like may be sent to first electronic component 101 in order to inform first electronic component 101 that removal of removable portion 103 is imminent. First electronic component 101 may use such a command in order to inhibit any non-reversible security actions that might be taken by first electronic component 101 upon detection of an unexpected or unauthorized removal of removable portion 103, such as data destruction or permanent lockout. The command may have an expiration time, after which it is no longer valid. A command may also be sent to second electronic component 111 in order to inform second electronic component 111 that, e.g., removable portion 103 is about to be attached to second electronic component 111, and that upon attachment of removable portion 103 a system state should be transferred from removable portion 103 to second electronic component 111.

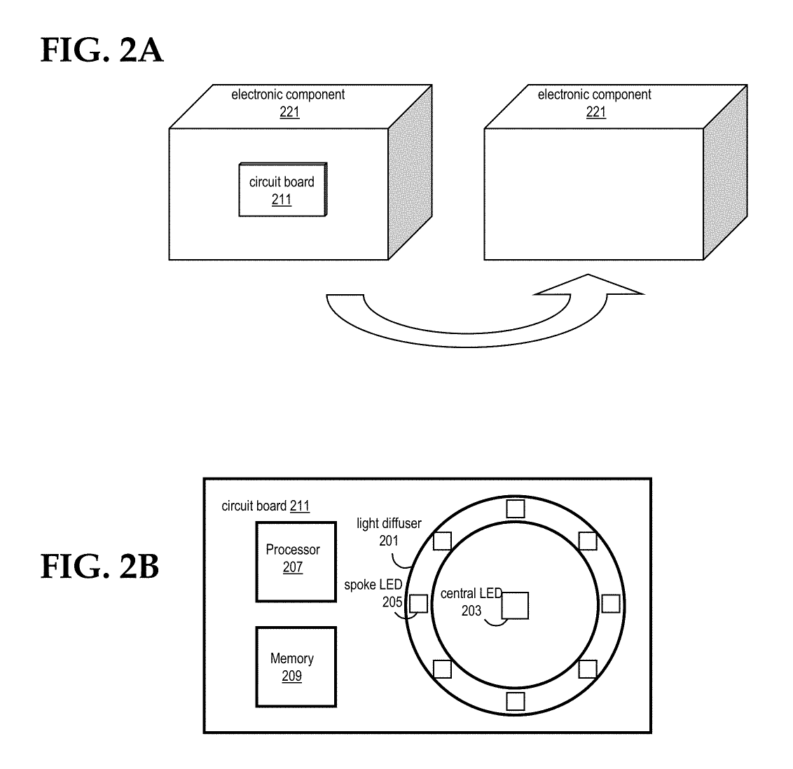

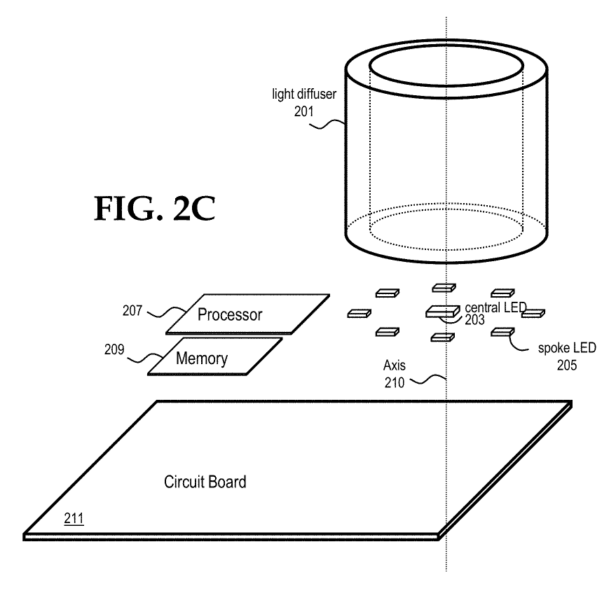

FIG. 2A illustrates an exploded view of a circuit module 200 in accordance with an embodiment of the present disclosure. Circuit module 200 is not drawn to scale, and is simplified to emphasize certain aspects of the embodiment. Well-known or conventional features may be omitted for sake of clarity. FIG. 2A illustrates circuit module 200 exploded along an axis parallel to axis 210. Circuit module 200 includes a circuit board 211, upon which are mounted light sources, e.g., a central light source (e.g., LED 203) and a plurality of spoke light sources (e.g., LEDs 205). Circuit module 200 illustrates eight spoke LEDs 205, but other embodiments may have more or fewer than eight spoke LEDs 205. Each of spoke LEDs 205 may be located at a predetermined distance from central LED 203, and in a predetermined pattern (e.g., in an arc pattern, a grid pattern, a linear pattern, etc.). In some embodiments, spoke LEDs 205 may all be located at a substantially equal distance from central LED 203. In some embodiments, spoke LEDs 205 may be located along an arc, with central LED 203 located at approximately the center of the arc. In some embodiments, spoke LEDs 205 may be equally-spaced along an arc fully encircling central LED 203, and in other embodiments spoke LEDs 205 may be equally-spaced only along an arc that does not fully encircle central LED 203. Central LED 203 and spoke LEDs 205 are configured to emit light principally along an axis parallel to axis 210, perpendicular to and away from circuit board 211. In some embodiments, central LED 203 may produce more lumens of light than a single, individual spoke LED 205. In some embodiments, central LED 203 may produce more lumens of light than spoke LEDs 205 collectively.

Central light source and spoke light sources may include non-LED light sources, such as a miniature incandescent bulb, a miniature gas discharge bulb, a miniature halogen bulb, etc.

Circuit module 200 may further include a processor 207, and a memory 209 coupled to processor 207. Memory 209 may store sets of programmed instructions that, when executed by processor 209, carries out or performs processes and methods in accordance with embodiments of the present disclosure. Circuit board 211 includes electrical connections (not illustrated) to interconnect electrically processor 207, memory 209, central LED 203 and/or spoke LEDs 205. Circuit module 200 may further include a light diffuser 201 mounted over a light-emitting surface of at least spoke LEDs 205. Light diffuser 201 is illustrated as having a cylindrical shape, but other shapes may be used such as a hyperboloid shape, a conical shape, etc.

FIG. 2B illustrates a top plan view of an assembled circuit module 200. Light diffuser 201 is mounted on circuit module 200 such that a solid portion of light diffuser 201 is directly above spoke LEDs 205, and central LED 203 is within or under a central portion of light diffuser 201. Spoke LEDs 205 may be arranged to be substantially mutually coplanar and coplanar with central LED 203. Placement of other elements of circuit module 200 on circuit board 201 are up to a designer's discretion. Light diffuser 201 is constructed from a material that is light-transmissive, e.g., transparent, translucent, or a combination of both. For example, light diffuser 201 may be constructed from a plastic or plastic-type material that is substantially transparent at visible wavelengths along a length (i.e., the height along axis 210) of light diffuser 201. Light diffuser 201 may include design elements that scatter light from spoke LEDs 205, e.g., a surface roughness over at least a portion of light diffuser 201 that allows light to escape due to a local angle of air-surface interface in accordance with Snell's law, or reflective particles embedded or infused within the material of light diffuser 201, etc. Light diffuser 201 diffuses light at least from spoke LEDs 205, and allows the light from spoke LEDs 205 to be visible over a relatively greater range of solid angles with respect to axis 210 (i.e., off-axis directions), and have improved visibility of the spoke LED 205 light at such off-axis directions, compared to the visibility of spoke LEDs 205 without diffuser 201. In some embodiments, diffuser 201 also may improve visibility of light from central LED 203 over a greater solid angle.

Light diffuser 201 is illustrated as being hollow, but in other embodiments may be at least partially filled with a material that is transparent, translucent, or a combination of both. The material over central LED 203 may be the same or different than the material over spoke LEDs 205, and may include design elements that scatter light from central LED 203 (e.g., surface roughness or embedded reflective particles, etc.). A different material may cause light from central LED 203 to be stovepiped out of light diffuser 201 due to differences in indices of refraction, i.e., similar to guided-wave light transmission. In some embodiments, a lens may be placed over central LED 203 in order to spread out light from central LED 203 and further improve diffusion of light.

Circuit module 200 is operated in order to indicate an equipment status, e.g., a status of circuit module 200 itself while processor 207 performs additional functions, or a status of an electronic component, module, etc. communicatively coupled to circuit module 200. For example, processor 207 may be programmed to perform a separate function (e.g., compressing data, verifying data integrity, etc.), and central LED 203 and/or spoke LEDs may be configured to change state based upon the separate function being performed by processor 207. In another example, circuit module 200 may receive status indications from an electronic component external to circuit module 200, and central LED 203 and/or spoke LEDs may be configured to change state based upon the received status indications.

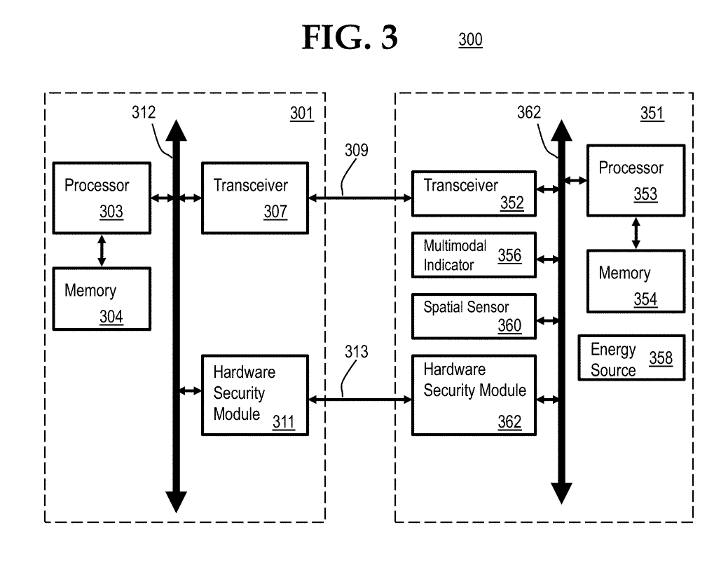

FIG. 3 illustrates a functional block diagram of system 300, comprising first electronic component 301 and removable portion 351. First electronic component 301 may contain sensitive data that is to be protected from unauthorized access or disclosure. For example, the data may have been obtained by gathering the data (e.g., from sensors, data feeds, user input, etc.), or calculating the data, or storing the data (e.g., a database of sensitive information), or so forth. Protection of sensitive data within first electronic component 301 may be provided by a symbiotic interaction with removable portion 351.

First electronic component 301 includes a processor 303 coupled to a memory 304. Memory 304 may include a combination of volatile memory (e.g., RAM) and nonvolatile memory (e.g., a disk drive). Processor 303 is further coupled through communication bus 312 to transceiver 307. Transceiver 307 is coupled through communication link 309 to removable portion 351.

First electronic component 301 further includes a hardware security module 311 coupled via link 313 to a corresponding hardware security module 362 in removable portion 351. Hardware security module 311 supports detection of whether removable portion 351 had been removed from first electronic component 301. Some embodiments may implement portions of hardware security module 311 as part of an appropriately-programmed processor 303. Link 313 may represent a link usable for active sensing (e.g., a communication link), or may represent a coupling whose presence or lack of presence may be usable for passive sensing (e.g., weight scale, Hall effect magnetic sensing, light for a photosensor, atmospheric gas detector, etc.).

Removable portion 351 includes a transceiver 352 externally coupled to communication link 307 and internally coupled to communication bus 362. Communication bus 362 interconnects transceiver 352, processor 353, multimodal indicator 356 and spatial sensor 360. Processor 353 is further coupled to a memory 354. Memory 354 may include a combination of volatile memory (e.g., RAM) and nonvolatile memory (e.g., a disk drive). Processor 353 is programmable to execute various serial and/or concurrent processes, including a process to provide a timer. An energy source 358 (e.g., a battery or supercaps) may provide power to removable portion 351 when removable portion 351 is detached.

Removable portion 351 further may include hardware security module 362, which cooperates over link 313 with hardware security module 311 in first electronic component 301, to detect when removable portion 351 is disconnected from first electronic component 301. For example, hardware security module 362 may produce an active signal, transmitted via link 313, whose presence is detected by hardware security module 311.

Spatial sensor 360 may be operable to sense or to measure a position or an orientation. A position can be with respect to an invariate reference, e.g., distance and direction from a reference point such as a beacon, or coordinates such as latitude, longitude and altitude. A position can also be with respect to a relative reference, e.g., being within a predetermined distance of first electronic component 301. An orientation can be with respect to rotation around one or more of the X-axis, Y-axis or Z-axis as illustrated in FIGS. 2A-2B. Orientation may be measured by a 3-axis accelerometer that measure the direction of the force of gravity exerted on removable portion 351.

In one embodiment, removable portion 351 may be implemented as second electronic component 211 depicted in FIGS. 2A-2B. In this embodiment, processor 353 corresponds to processor 207, memory 354 corresponds to memory 209, and multimodal indicator 356 corresponds to the combination of light diffuser 201, central LED 203 and spoke LEDs 205.

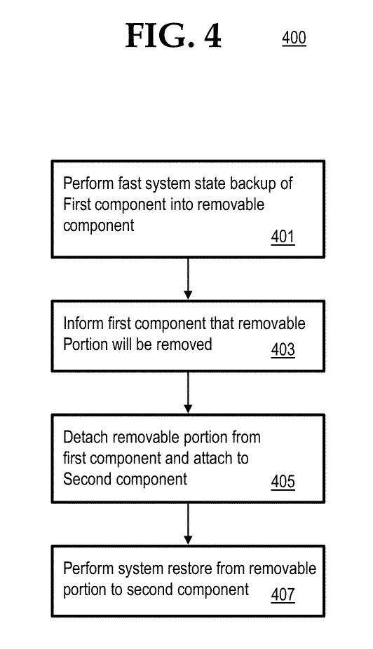

FIG. 4 illustrates a method 400 to transfer personality and data via physical movement of a fast memory transfer device (e.g., removable portion 103) from a first device (e.g., first electronic component 101 or 301) to a second device (e.g., second electronic component 111). Method 400 begins at step 401 at which a fast system state backup of first electronic component 101 is performed and the results stored into removable portion 103.

Next, control of method 400 proceeds to step 403 at which a communication (e.g., a message) is sent to first electronic component 101 to inform it that an authorized removal of removable portion 103 is about to occur. The message may originate from an external system controller, a human operator console, or the like (not illustrated). This message will be a cue to first electronic component 101 to prevent actions that may be performed due to an unanticipated or unauthorized removal of removable component 103.

Optionally, a message also may be sent to second electronic component 111 to inform it to expect attachment of removable component 103. Such a message may cause second electronic component 111 to prepare for a change of state (e.g., terminate processes, save data, etc.).

Next, control of method 400 proceeds to step 405 at which removable component 103 is removed from first electronic component 101 and is attached to second electronic component 111. Second electronic component 111 will detect the attachment of removable component 103 and initiate transfer of personality and data from removable component 103 to second electronic component 111. Alternatively, removable component 103 may detect attachment of itself to second electronic component 111, and issue a command to second electronic component 111 to initiate transfer of personality and data from removable component 103 to second electronic component 111.

Next, control of method 400 proceeds to step 407 at which a system restore (e.g., personality and data) is performed from removable component 103 to second electronic component 111.

Embodiments of the present disclosure include a system having one or more processing units coupled to one or more memories. The one or more memories may be configured to store software that, when executed by the one or more processing unit, allows practice of embodiments described herein, at least by use of processes described herein, including at least in FIG. 2 and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present disclosure may be dependent on various considerations, such as the speed or efficiency requirements of the system, the particular function, and the particular software or hardware systems being utilized.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed. Modifications and variations are possible in light of the above teachings or may be acquired from practice of the disclosure. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the disclosure unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112(f), and any claim without the word “means” is not so intended.

1. A system to transferably store a system state of an electronic component, comprising:
a processor configured:
to decompose the system state into a plurality of data vectors; and
to map each of the plurality of data vectors to a respective bit marker; and
a circuit module removably coupled to the electronic component, the circuit module externally accessible from an exterior of the electronic component, the circuit module comprising:
a memory; and
a transceiver coupled to the memory and to a communication link between the memory and the processor, the transceiver operable to send and to receive data at a rate faster than 640 MBps;
wherein data sent and received by the transceiver comprises bit markers mapped by the processor.

2. The system of claim 1, wherein the circuit module is removable by hand.

3. The system of claim 1, wherein the communication link comprises a data bus capable of supporting greater than 640 MBps.

4. The system of claim 1, wherein the circuit module comprises the processor and a device controller.

5. The system of claim 1, wherein the system state comprises installed programs, operating programs, data used by programs, memory contents, machine state, network and infrastructure configuration, security information and permissions, and data objects.

6. The system of claim 1, further comprising a hardware security module to detect removal of the circuit module from the electronic component.

7. The system of claim 6, wherein the hardware security module comprises a passive sensor.

8. The system of claim 6, wherein the electronic component transitions to a paralyzed operating state upon detected removal of the circuit module from the electronic component.

9. The system of claim 6, wherein the hardware security module inhibits restart of the electronic component upon detected removal of the circuit module from the electronic component.

10. The system of claim 6, wherein the hardware security module inhibits usage of additional system resources by the electronic component upon detected removal of the circuit module from the electronic component.

11. A method to transferably store a system state of an electronic component, comprising:
decomposing, by a processor in the electronic component, the system state into a plurality of data vectors;
mapping, by the processor, each of the plurality of data vectors to a respective bit marker;
storing the bit markers in a memory of a circuit module removably coupled to the electronic component, the circuit module externally accessible from an exterior of the electronic component;
detecting removal of the circuit module from the electronic component; and
changing an operating state of the electronic component upon detection of removal of the circuit module.

12. The method of claim 11, wherein the step of storing comprises communicating between the circuit module and the electronic component via a PCI-e data bus.

13. The method of claim 11, wherein the system state comprises installed programs, operating programs, data used by programs, memory contents, machine state, network and infrastructure configuration, security information and permissions, and data objects.

14. The method of claim 11, wherein detecting removal of the circuit module comprises passive sensing of a presence of the circuit module.

15. The method of claim 11, further comprising the step of providing an active signal to sense a presence of the circuit module.

16. The method of claim 11, further comprising the step of transitioning to a paralyzed operating state upon detected removal of the circuit module from the electronic component.

17. The method of claim 11, further comprising the step of inhibiting restart of the electronic component upon detected removal of the circuit module from the electronic component.

18. The method of claim 11, further comprising the step of inhibiting usage of additional system resources by the electronic component upon detected removal of the circuit module from the electronic component.
